(19) United States
(12) Patent Application Publication
(10) Pub. No.: US 2026/0237744 A1
(43) Pub. Date: Aug. 13, 2026

(54) ELECTROCHEMICAL APPARATUS AND ELECTRONIC APPARATUS

(71) Applicant: Ningde Amperex Technology Limited, Ningde (CN)

(72) Inventors: Zhiyi GAO, Ningde (CN); Chao TANG, Ningde (CN)

(73) Assignee: Ningde Amperex Technology Limited, Ningde (CN)

(21) Appl. No.: 19/537,598

(22) Filed: Feb. 12, 2026

(30) Foreign Application Priority Data
Feb. 12, 2025 (CN) 202510154974.3

(51) Int. Cl. H01M 10/0568; H01M 10/052

(52) U.S. Cl. CPC H01M 10/0568; H01M 10/052

(57) ABSTRACT

An electrochemical apparatus has a volumetric energy density of 850 Wh/L to 900 Wh/L and includes a positive electrode, a negative electrode, and an electrolyte. Based on a mass of the electrolyte, the electrolyte includes ethylene carbonate with a mass percentage of A %, propylene carbonate with a mass percentage of B %, ethyl propionate with a mass percentage of C %, and propyl propionate with a mass percentage of D %; where 0.02≤(A+B)/(C+D)≤0.5 and 1≤D/C≤10.

### CROSS-REFERENCE TO RELATED APPLICATION

This application claims the benefit of priority from the Chinese Patent Application No. 202510154974.3, filed on Feb. 12, 2025, the entire content of which is incorporated herein by reference.

### TECHNICAL FIELD

This application pertains to the field of energy storage technology and specifically relates to an electrochemical apparatus and an electronic apparatus.

### BACKGROUND

Secondary batteries, as rechargeable energy storage apparatuses, achieve mutual conversion between electrical energy and chemical energy through chemical reactions during the charge-discharge process. Currently, secondary batteries, with their high energy density, long cycle life, and environmental friendliness, are widely used in fields such as mobile communication, electric vehicles, and energy storage systems.

High volumetric energy density of secondary batteries allows them to achieve stronger endurance in a smaller volume and have the advantages such as lightness and portability. However, secondary batteries with high volumetric energy density are prone to thickness increase after long-term use. Such thickness increase not only affects charge-discharge efficiency of the battery, reducing energy density and power density of the battery, but also accelerates the aging of the battery, shortening the cycle life of the battery. Therefore, to improve the comprehensive performance of secondary batteries, how to alleviate thickness increase of batteries with high volumetric energy density has become an urgent problem to be solved.

### SUMMARY

In view of this, this application provides an electrochemical apparatus and an electronic apparatus. Adjusting the electrolyte formulation improves the stability of an electrochemical apparatus system, alleviating the thickness growth problem and helping to reduce the overall impedance of the electrochemical apparatus.

According to a first aspect, this application provides an electrochemical apparatus including a positive electrode, a negative electrode, and an electrolyte, where the electrochemical apparatus has a volumetric energy density of 850 Wh/L to 900 Wh/L; and based on a mass of the electrolyte, the electrolyte includes ethylene carbonate with a mass percentage of A %, propylene carbonate with a mass percentage of B %, ethyl propionate with a mass percentage of C %, and propyl propionate with a mass percentage of D %; where 0.02≤(A+B)/(C+D)≤0.5, and 1≤D/C≤10.

In this application, ethylene carbonate and propylene carbonate are added to the electrolyte and can participate in forming a solid electrolyte interphase film (a CEI film or an SEI film). However, the SEI film formed by propylene carbonate is not very stable and has the problem of relatively high viscosity. Based on this, propyl propionate and ethyl propionate are used in this application in combination with the above carbonates. Propyl propionate has relatively low viscosity. Adjusting the percentages of propyl propionate and ethyl propionate and the percentages of the above carbonates to satisfy the above relationships can offset the viscosity increase caused by using propylene carbonate and ethylene carbonate, accelerate lithium ion transport between the positive and negative electrodes in an electrochemical apparatus with a high volumetric energy density, improve the kinetic performance of the electrochemical apparatus, and reduce overall impedance and impedance growth rate of the electrochemical apparatus. On the other hand, utilizing the characteristic that propyl propionate has a wider electrochemical window than other carboxylate solvents, after propyl propionate is used in combination with ethyl propionate, the polarization degree of a battery can be reduced, the stability of positive and negative electrode interfaces can be improved, and interfacial side reactions can be reduced, thereby suppressing an absolute value of thickness growth of the battery. Through the cooperative effect of the above substances, both impedance growth rate and thickness growth rate after cycling of the electrochemical apparatus can be alleviated under a condition that the high volumetric energy density is ensured.

In some embodiments, the electrolyte satisfies at least one of the following conditions: (1) 2≤A≤10; (2) 2≤B≤10; (3) 10≤C≤15; (4) 45≤D≤70; (5) 0.05≤(A+B)/(C+D)≤0.36; or (6) 3≤D/C≤7. When the mass percentages of the components in the electrolyte are adjusted to satisfy the above ranges, the cooperative effect of the components in an electrochemical apparatus system can be improved, further reducing the impedance growth rate and thickness growth rate during cycling of the electrochemical apparatus.

In some embodiments, the electrolyte includes fluoroethylene carbonate or 1,3-propane sultone. Fluoroethylene carbonate (FEC) is added to the electrolyte of this application, which can further strengthen protection on a negative electrode side and reduce side reactions and product accumulation at a negative electrode interface, thereby reducing the thickness growth rate of the electrochemical apparatus during cycling. In this application, 1,3-propane sultone (1,3-PS) is added to the electrolyte, which can participate in film formation at the negative electrode and alleviate side reactions and gas generation at the negative electrode interface during cycling, thereby helping to reduce the impedance growth rate and thickness growth rate during cycling of the electrochemical apparatus.

In some embodiments, based on the mass of the electrolyte, a mass percentage of fluoroethylene carbonate is P %, and a mass percentage of 1,3-propane sultone is Q %, where 10≤P≤40, and 1≤Q≤6. Adjusting the mass percentages of fluoroethylene carbonate or 1,3-propane sultone in the electrolyte respectively to satisfy the above ranges helps to promote better cooperation of the two with ethylene carbonate and improve the film-forming quality at the negative electrode interface. The inventors have unexpectedly found that in an electrolyte system of this application, based on the difference in film formation between the two, fluoroethylene carbonate can reduce the thickness growth rate during cycling of the electrochemical apparatus, and 1,3-propane sultone can reduce the impedance growth rate and thickness growth rate during cycling of the electrochemical apparatus.

In some more preferred embodiments, from the perspective of further reducing the impedance growth rate and thickness growth rate during cycling of the electrochemical apparatus, 12≤P≤20, or 2≤Q≤4.

In some embodiments, the electrolyte includes 1,3,6-hexanetricarbonitrile; and based on the mass of the electrolyte, a mass percentage of 1,3,6-hexanetricarbonitrile is R %, where 2≤R≤3. In this application, 1,3,6-hexanetricarbonitrile is added to the electrolyte, which can specifically complex with transition metal sites exposed at a positive electrode interface, reducing oxidative decomposition capability on the electrolyte, thereby reducing side reactions and gas production inside the electrochemical apparatus and reducing the impedance growth rate and thickness growth rate during cycling.

In some embodiments, the electrolyte includes lithium bis(trifluoromethanesulfonyl)imide; and based on the mass of the electrolyte, a mass percentage of lithium bis(trifluoromethanesulfonyl)imide is S %, where 0.5≤S≤1. In this application, lithium bis(trifluoromethanesulfonyl)imide is added to the electrolyte, which can improve high-temperature storage stability of the electrolyte, increase the decomposition temperature of the lithium salt, form films at the positive and negative electrode interfaces, and suppress interfacial side reactions, thereby further reducing the impedance growth rate and thickness growth rate during cycling of the electrochemical apparatus.

In some embodiments, the electrolyte includes a first substance, and the first substance is selected from vinyl sulfate or vinyl bisulfate; and based on the mass of the electrolyte, a mass percentage of the first substance is U %, where 2≤U≤3. In this application, vinyl sulfate or vinyl bisulfate is added to the electrolyte, which can improve the film-forming quality at the negative electrode, improve the charge-discharge performance and number of cycles of the battery, and alleviate swelling of the battery after high-temperature storage, thereby further reducing the impedance growth rate and thickness growth rate during cycling of the electrochemical apparatus.

In some embodiments, the electrolyte satisfies at least one of the following conditions:
(1) the electrolyte includes dicyclohexyl(trifluoromethanesulfonyloxy)borane, and based on the mass of the electrolyte, a mass percentage of dicyclohexyl(trifluoromethanesulfonyloxy)borane is X %, where 0.5≤X≤1;
(2) the electrolyte includes 2,3-pyridinedicarboxylic anhydride, and based on the mass of the electrolyte, a mass percentage of 2,3-pyridinedicarboxylic anhydride is Y %, where 0.3≤Y≤0.8; or
(3) the electrolyte includes 6-(morpholin-4-yl)pyridine-3-boronic acid pinacol ester, and based on the mass of the electrolyte, a mass percentage of 6-(morpholin-4-yl)pyridine-3-boronic acid pinacol ester is Z %, where 0.5≤Z≤0.8.

Based on the solution, in above this application, dicyclohexyl(trifluoromethanesulfonyloxy)borane is added to the electrolyte, which can alleviate high-temperature storage gas production and reduce side reactions, further reducing the impedance growth rate and thickness growth rate during cycling of the electrochemical apparatus. In this application, 2,3-pyridinedicarboxylic anhydride is added to the electrolyte, which can improve the film-forming quality on the negative electrode side and alleviate high-temperature storage gas production and cycling, further reducing the impedance growth rate and thickness growth rate during cycling of the electrochemical apparatus. In this application, 6-(morpholin-4-yl)pyridine-3-boronic acid pinacol ester is added to the electrolyte, which can improve the film-forming quality at the positive and negative electrode interfaces, especially reduce impedance on the positive electrode side and improve the kinetic performance, improving the high-temperature cycling performance, thereby further reducing the impedance growth rate and thickness growth rate during cycling of the electrochemical apparatus.

In some embodiments, the positive electrode includes a positive electrode current collector and a positive electrode active material layer located on at least a part of a surface of the positive electrode current collector, the positive electrode active material layer includes a positive electrode active material, and the positive electrode active material has a general formula of LiₐCO_{1-b}M_{b}O_{2-b}, where 0.99≤a≤1.01, 0.01≤b≤0.05, and M is at least one selected from the group consisting of Na, Mg, Al, Zr, Ti, Y, Ni, Mn, V, Cr, La, and Ce. The above positive electrode active material is used in combination with an electrolyte system of this application, which helps to optimize the film-forming quality on the positive electrode side, improving the kinetic performance, thereby further reducing the impedance growth rate and thickness growth rate during cycling of the electrochemical apparatus.

According to a second aspect, this application provides an electronic apparatus including the electrochemical apparatus according to any one of the above embodiments.

### DETAILED DESCRIPTION

To make the objectives, technical solutions, and advantages of this application clearer, the following further describes this application in detail with reference to some embodiments. It should be understood that the specific embodiments described herein are only used to explain this application and are not intended to limit this application.

According to a first aspect, this application provides an electrochemical apparatus including a positive electrode, a negative electrode, and an electrolyte, where the electrochemical apparatus has a volumetric energy density of 850 Wh/L to 900 Wh/L; and based on a mass of the electrolyte, the electrolyte includes ethylene carbonate with a mass percentage of A %, propylene carbonate with a mass percentage of B %, ethyl propionate with a mass percentage of C %, and propyl propionate with a mass percentage of D %; where 0.02≤(A+B)/(C+D)≤0.5, and 1≤D/C≤10.

The inventors have found that secondary batteries with high volumetric energy density have very tightly packed electrode materials. During long-term cycling, complex electrochemical reactions occur inside the battery, causing volume expansion and contraction of the electrode materials, leading to pulverization and detachment problems, thus gradually increasing the thickness of the battery. To solve this problem, carbonates and carboxylates are used in combination in the electrolyte of this application. The carbonates include ethylene carbonate and propylene carbonate, and the carboxylates include ethyl propionate and propyl propionate. By adjusting the mass percentage relationships of the above carbonates, the above carboxylates, ethyl propionate, and propyl propionate, the formation of high-quality solid electrolyte interphase films on the surfaces of the positive and negative electrodes can be facilitated, the stability of the interfaces can be improved, side reactions between the positive and negative electrodes and the electrolyte can be reduced, and overall thickness growth during cycling of the electrochemical apparatus can be reduced. In addition, through the cooperation between the above carboxylates and the above carbonates, the kinetic performance can be improved in an electrochemical apparatus with a high volumetric energy density, helping to reduce the overall impedance growth of the electrochemical apparatus.

Based on the above solution, the volumetric energy density of the electrochemical apparatus of this application can be maintained at a relatively high level, for example, 850 Wh/L to 900 Wh/L. Exemplarily, the volumetric energy density may be 850 Wh/L, 855 Wh/L, 857 Wh/L, 863 Wh/L, 869 Wh/L, 877 Wh/L, 882 Wh/L, 888 Wh/L, 889 Wh/L, 897 Wh/L, 900 Wh/L, or a value within a range defined by any two of these values. Moreover, through the cooperation of the above carbonates and carboxylates, the overall impedance growth and overall thickness growth during cycling of the electrochemical apparatus can be reduced.

In some embodiments, 0.02≤(A+B)/(C+D)≤0.5, preferably 0.05≤(A+B)/(C+D)≤0.36. Exemplarily, the value of (A+B)/(C+D) may be 0.02, 0.04, 0.08, 0.16, 0.19, 0.25, 0.29, 0.38, 0.42, 0.46, 0.5, or a value within a range defined by any two of these values. When the value of (A+B)/(C+D) is adjusted to satisfy the above range, better cooperation between the carbonates and carboxylates of this application can be facilitated, further reducing the impedance growth rate and thickness growth rate during cycling of the electrochemical apparatus.

In some embodiments, 1≤D/C≤10, preferably 3≤D/C≤7. Exemplarily, the value of D/C may be 1, 1.4, 2.1, 3.1, 4.5, 5.6, 6.3, 7.6, 8.1, 9.2, 10, or a value within a range defined by any two of these values. Adjusting the mass percentages of propyl propionate and ethyl propionate to satisfy the above relationship can further reduce the impedance growth of the electrochemical apparatus and reduce the thickness growth rate during cycling.

In some embodiments, 2≤A≤10. For example, A may be 2, 3, 4, 5, 6, 7, 8, 9, 10, or a value within a range defined by any two of these values. Adjusting the mass percentage of ethylene carbonate in the electrolyte within the above range helps to further reduce the impedance growth rate and thickness growth rate during cycling of the electrochemical apparatus.

In some embodiments, 2≤B≤10. For example, B may be 2, 3, 4, 5, 6, 7, 8, 9, 10, or a value within a range defined by any two of these values. Adjusting the mass percentage of propylene carbonate in the electrolyte within the above range helps to further reduce the impedance growth rate and thickness growth rate during cycling of the electrochemical apparatus.

In some embodiments, 10≤C≤15. For example, C may be 10, 11, 12, 13, 14, 15, or a value within a range defined by any two of these values. Adjusting the mass percentage of ethyl propionate in the electrolyte to satisfy the above range can further reduce the impedance growth rate and thickness growth rate during cycling of the electrochemical apparatus.

In some embodiments, 45≤D≤70. For example, D may be 45, 49, 51, 56, 57, 60, 63, 65, 70, or a value within a range defined by any two of these values. Adjusting the mass percentage of propyl propionate in the electrolyte to satisfy the above range can further reduce the impedance growth rate and thickness growth rate during cycling of the electrochemical apparatus.

In some embodiments, the electrolyte includes fluoroethylene carbonate; and based on the mass of the electrolyte, a mass percentage of fluoroethylene carbonate is P %, where 10≤P≤40, preferably 12≤P≤20. Exemplarily, P may be 10, 15, 18, 22, 25, 28, 33, 35, 37, 40, or a value within a range defined by any two of these values.

When the mass percentage of fluoroethylene carbonate in the electrolyte is adjusted to satisfy the above range, better cooperation of fluoroethylene carbonate with ethylene carbonate is facilitated, the film-forming quality at the negative electrode interface is improved, and the thickness growth rate during cycling of the electrochemical apparatus is further reduced.

In some embodiments, the electrolyte includes 1,3-propane sultone; and based on the mass of the electrolyte, a mass percentage of 1,3-propane sultone is Q %, where 1≤Q≤6, preferably 2≤Q≤4. Exemplarily, Q may be 1, 1.4, 1.8, 2.5, 2.7, 3.3, 4.2, 4.6, 4.9, 5.6, 6, or a value within a range defined by any two of these values. When the mass percentage of 1,3-propane sultone in the electrolyte is adjusted to satisfy the above range, better cooperation of 1,3-propane sultone with ethylene carbonate is facilitated, the film-forming quality at the negative electrode interface is improved, and the impedance growth rate and thickness growth rate during cycling of the electrochemical apparatus are further reduced.

In some embodiments, the electrolyte includes 1,3,6-hexanetricarbonitrile; and based on the mass of the electrolyte, a mass percentage of 1,3,6-hexanetricarbonitrile is R %, where 2≤R≤3. For example, R may be 2, 2.1, 2.2, 2.3, 2.4, 2.5, 2.6, 2.7, 2.8, 2.9, 3, or a value within a range defined by any two of these values. When the mass percentage of 1,3,6-hexanetricarbonitrile in the electrolyte is adjusted to satisfy the above range, the impedance growth rate and thickness growth rate during cycling of the electrochemical apparatus can be further reduced.

In some embodiments, the electrolyte includes lithium bis(trifluoromethanesulfonyl)imide LiN(CF₃SO₂)₂ (LiTFSI); and based on the mass of the electrolyte, a mass percentage of lithium bis(trifluoromethanesulfonyl)imide is S %, where 0.5≤S≤1. For example, S may be 0.5, 0.6, 0.7, 0.8, 0.9, 1, or a value within a range defined by any two of these values. When the mass percentage of lithium bis(trifluoromethanesulfonyl)imide in the electrolyte is adjusted to satisfy the above range, the impedance growth rate and thickness growth rate during cycling of the electrochemical apparatus can be further reduced.

In some embodiments, the electrolyte includes a first substance, and the first substance is selected from vinyl sulfate or vinyl bisulfate; and based on the mass of the electrolyte, a mass percentage of the first substance is U %, where 2≤U≤3. For example, U may be 2, 2.1, 2.2, 2.3, 2.4, 2.5, 2.6, 2.7, 2.8, 2.9, 3, or a value within a range defined by any two of these values. When the mass percentage of the first substance in the electrolyte is adjusted to satisfy the above range, the impedance growth rate and thickness growth rate during cycling of the electrochemical apparatus can be further reduced.

In some embodiments, the electrolyte includes dicyclohexyl(trifluoromethanesulfonyloxy)borane; and based on the mass of the electrolyte, a mass percentage of dicyclohexyl(trifluoromethanesulfonyloxy)borane is X %, where 0.5≤X≤1. For example, X may be 0.6, 0.7, 0.8, 0.9, 1, or a value within a range defined by any two of these values. When the mass percentage of dicyclohexyl(trifluoromethanesulfonyloxy)borane in the electrolyte is adjusted to satisfy the above range, dicyclohexyl(trifluoromethanesulfonyloxy)borane cooperates with the electrolyte system of this application, so that the impedance growth rate and thickness growth rate during cycling of the electrochemical apparatus can be further reduced.

In some embodiments, the electrolyte includes 2,3-pyridinedicarboxylic anhydride; and based on the mass of the electrolyte, a mass percentage of 2,3-pyridinedicarboxylic anhydride is Y %, where 0.3≤Y≤0.8. For example, Y may be 0.3, 0.4, 0.5, 0.6, 0.7, 0.8, or a value within a range defined by any two of these values. When the mass percentage of 2,3-pyridinedicarboxylic anhydride in the electrolyte is adjusted to satisfy the above range, 2,3-pyridinedicarboxylic anhydride cooperates with the electrolyte system of this application, so that the impedance growth rate and thickness growth rate during cycling of the electrochemical apparatus can be further reduced.

In some embodiments, the electrolyte includes 6-(morpholin-4-yl)pyridine-3-boronic acid pinacol ester; and based on the mass of the electrolyte, a mass percentage of 6-(morpholin-4-yl)pyridine-3-boronic acid pinacol ester is Z %, where 0.5≤Z≤0.8. For example, Z may be 0.5, 0.6, 0.7, 0.8, or a value within a range defined by any two of these values. When the mass percentage of 6-(morpholin-4-yl)pyridine-3-boronic acid pinacol ester in the electrolyte is adjusted to satisfy the above range, 6-(morpholin-4-yl)pyridine-3-boronic acid pinacol ester cooperates with the electrolyte system of this application, so that the impedance growth rate and thickness growth rate during cycling of the electrochemical apparatus can be further reduced.

According to some embodiments of this application, the electrolyte further includes a lithium salt and a non-aqueous solvent. The lithium salt may include but is not limited to at least one of lithium hexafluorophosphate (LiPF₆), lithium bis(fluorosulfonyl)imide Li(N(SO₂F)₂) (LiFSI), lithium bis(oxalato) borate LiB(C₂O₄)₂ (LiBOB), lithium difluoro (oxalato) borate LiBF₂(C₂O₄)(LiDFOB), LiNO₃, LiClO₄, LiB(C₆H₅)₄, LiCH₃SO₃, LiCF₃SO₃, LiC(SO₂CF₃)₃, or Li₂SiF₆. This application imposes no limitation on a percentage of the lithium salt in the electrolyte, provided that the objectives of this application can be achieved. This application imposes no particular limitation on the non-aqueous solvent, provided that the objectives of this application can be achieved. For example, the non-aqueous solvent may include but is not limited to at least one of an ether compound or another organic solvent. The above ether compound may include but is not limited to at least one of 1,3-dioxolane (DOL), ethylene glycol dimethyl ether (1,2-dimethoxyethane, DME), dibutyl ether, tetraethylene glycol dimethyl ether, diethylene glycol dimethyl ether, 1,2-diethoxyethane, 1-ethoxy-1-methoxyethane, 2-methyltetrahydrofuran, or tetrahydrofuran. The above another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

This application imposes no particular limitation on the positive electrode, provided that the objectives of this application can be achieved. For example, the positive electrode includes a positive electrode current collector and a positive electrode active material layer located on at least one surface of the positive electrode current collector. The “positive electrode active material layer located on at least one surface of the positive electrode current collector” means that the positive electrode active material layer may be located on one surface of the positive electrode current collector in a thickness direction or on both surfaces of the positive electrode current collector in the thickness direction. It should be noted that the “surface” herein may be an entire region of the surface of the positive electrode current collector or a partial region of the surface of the positive electrode current collector, which is not particularly limited in this application, provided that the objectives of this application can be achieved.

This application imposes no particular limitation on the positive electrode current collector, provided that the objectives of this application can be achieved. For example, the positive electrode current collector may include an aluminum foil, an aluminum alloy foil, or a composite current collector (for example, an aluminum-carbon composite current collector). The composite current collector may be formed by forming a metal material (copper, copper alloy, nickel, nickel alloy, titanium, titanium alloy, silver, silver alloy, or the like) on a polymer substrate.

The positive electrode active material layer of this application includes a positive electrode active material. This application imposes no particular limitation on the type of the positive electrode active material, provided that the objectives of this application can be achieved. For example, the positive electrode active material may include at least one of lithium nickel cobalt manganese oxide (LiNi_{0.90}Co_{0.05}Mn_{0.05}O₂ (NCM955), NCM811, NCM622, NCM523, NCM111), lithium nickel cobalt aluminate, lithium iron phosphate, lithium vanadium phosphate, lithium cobalt phosphate, lithium manganese phosphate, lithium manganese iron phosphate, a lithium-rich manganese-based material, lithium cobalt oxide (LiCoO₂), lithium iron silicate, lithium vanadium silicate, lithium cobalt silicate, lithium manganese silicate, spinel-type lithium manganese oxide, spinel-type lithium nickel manganese oxide, or lithium titanate. In this application, the positive electrode active material may further include a non-metal element. For example, the non-metal element includes at least one of fluorine, phosphorus, boron, chlorine, silicon, or sulfur. In this application, there is no particular limitation on the thicknesses of the positive electrode current collector and the positive electrode active material layer, provided that the objectives of this application can be achieved. For example, the thickness of the positive electrode current collector is 5 μm to 20 μm, and the thickness of the positive electrode active material layer applied on one surface is 30 μm to 120 μm.

In some more preferred embodiments, the positive electrode includes a positive electrode current collector and a positive electrode active material layer located on at least a part of a surface of the positive electrode current collector. The positive electrode active material layer includes a positive electrode active material, and the positive electrode active material has a general formula of LiₐCo₁₋₆M_{b}O_{2-b}, where 0.99≤a≤1.01, 0.01≤b≤0.05, and M is at least one selected from the group consisting of Na, Mg, Al, Zr, Ti, Y, Ni, Mn, V, Cr, La, and Ce. The above positive electrode active material is used in combination with the electrolyte system of this application, which helps to optimize the film-forming quality on the positive electrode side, improving the kinetic performance, thereby further reducing the impedance growth rate and thickness growth rate during cycling of the electrochemical apparatus.

In this application, through optimization of the electrolyte and the positive electrode active material, after mutual interaction, an electrochemical apparatus system exhibits excellent stability, with a cut-off voltage reaching 4.5 V to 4.52 V, which can ensure full release of charge-discharge performance of the electrochemical apparatus.

In this application, the positive electrode active material layer may further include a positive electrode binder and a positive electrode conductive agent. This application imposes no particular limitation on the type of the positive electrode binder in the positive electrode active material layer, provided that the objectives of this application can be achieved. For example, the positive electrode binder may include but is not limited to at least one of polyvinylidene fluoride, polytetrafluoroethylene, polyolefins, sodium carboxymethyl cellulose, lithium carboxymethyl cellulose, modified polyvinylidene fluoride, modified styrene-butadiene rubber (SBR), or polyurethane. In some embodiments, the polyolefin binder includes at least one of polyethylene, polypropylene, polyolefin ester, polyolefin alcohol, or polyacrylic acid.

This application imposes no particular limitation on the type of the positive electrode conductive agent in the positive electrode active material layer, provided that the objectives of this application can be achieved. In some embodiments, the positive electrode conductive agent includes: a carbon-based material, for example, natural graphite, artificial graphite, carbon black, acetylene black, Ketjen black, or carbon fiber; a metal-based material, for example, metal powder or metal fiber of copper, nickel, aluminum, or silver; a conductive polymer, for example, a polyphenylene derivative; or a mixture thereof. This application imposes no particular limitation on a mass ratio of the positive electrode active material, positive electrode conductive agent, and positive electrode binder in the positive electrode active material layer, and those skilled in the art may select according to actual needs, provided that the objectives of this application can be achieved. For example, a loading amount of the positive electrode active material in the positive electrode plate is 4.0 mg/cm² to 10.0 mg/cm².

This application imposes no particular limitation on the negative electrode plate, provided that the objectives of this application can be achieved. For example, the negative electrode plate includes a negative electrode current collector and a negative electrode active material layer disposed on at least one surface of the negative electrode current collector. In this application, the negative electrode active material layer may be disposed on one surface of the negative electrode current collector in a thickness direction or on both surfaces of the negative electrode current collector in the thickness direction. It should be noted that the “surface” herein may be an entire region of the negative electrode current collector or a partial region of the negative electrode current collector, which is not particularly limited in this application, provided that the objectives of this application can be achieved.

This application imposes no particular limitation on the negative electrode current collector, provided that the objectives of this application can be achieved. For example, the negative electrode current collector may include but is not limited to a copper foil, a copper alloy foil, a nickel foil, a stainless steel foil, a titanium foil, foamed nickel, foamed copper, or a composite current collector (for example, a carbon-coated copper composite current collector, a nickel-copper composite current collector, or a titanium-copper composite current collector). In this application, there is no particular limitation on the thicknesses of the negative electrode current collector and the negative electrode active material layer, provided that the objectives of this application can be achieved.

The negative electrode active material layer of this application includes a negative electrode active material. The negative electrode active material may include but is not limited to at least one of graphite, mesocarbon microbeads (MCMB), hard carbon, soft carbon, silicon, silicon-carbon composite, SiOₓ (0.5<x<1.6), Li—Sn alloy, Li—Sn—O alloy, Sn, SnO, SnO₂, spinel-structured lithium titanate-lithiated TiO₂—Li₄Ti₅O₁₂, Li—Al alloy, or metallic lithium.

The negative electrode active material layer in this application may further include a negative electrode binder and a negative electrode conductive agent, or the negative electrode active material layer may further include a negative electrode binder, a negative electrode conductive agent, and a thickener. This application imposes no particular limitation on the types of the negative electrode binder and the negative electrode conductive agent, provided that the objectives of this application can be achieved. For example, the negative electrode binder may include but is not limited to at least one of the above positive electrode binders. The negative electrode conductive agent may include but is not limited to at least one of the above positive electrode conductive agents. This application imposes no particular limitation on the type of the thickener, provided that the objectives of this application can be achieved. For example, the thickener may include but is not limited to at least one of sodium carboxymethyl cellulose or carboxymethyl cellulose. This application imposes no particular limitation on a mass ratio of the negative electrode active material, negative electrode conductive agent, negative electrode binder, and thickener in the negative electrode active material layer, and those skilled in the art may select according to actual needs, provided that the objectives of this application can be achieved.

There is no particular limitation on the electrochemical apparatus of this application. The electrochemical apparatus may include any apparatus where electrochemical reactions occur, for example, a secondary battery. The following takes a secondary battery as an example to illustrate this application in combination with some embodiments of this application. There is no particular limitation on the secondary battery of this application. For example, the secondary battery may include but is not limited to a lithium-ion secondary battery (also called a lithium-ion battery) or a sodium-ion secondary battery.

The secondary battery of this application further includes a separator. There is no particular limitation on the material and shape of the separator used in the secondary battery of this application, which may be any technology disclosed in the prior art. In some embodiments, the separator includes a polymer, an inorganic substance, or the like formed from a material stable to the electrolyte of this application.

For example, the separator may include a substrate layer and a surface treatment layer. The substrate layer is a non-woven fabric, film, or composite film having a porous structure. The material of the substrate layer is selected from at least one of polyethylene, polypropylene, polyethylene terephthalate, or polyimide. Specifically, a polypropylene porous film, a polyethylene porous film, a polypropylene non-woven fabric, a polyethylene non-woven fabric, or a polypropylene-polyethylene-polypropylene porous composite film may be used.

At least one surface of the substrate layer is provided with a surface treatment layer, where the surface treatment layer may be a polymer layer or an inorganic substance layer, or may be a layer formed by mixing a polymer and an inorganic substance. The inorganic substance layer includes inorganic particles and a binder. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinylether, polymethyl methacrylate, polytetrafluoroethylene, or polyhexafluoropropylene. The polymer layer contains a polymer. The material of the polymer is selected from at least one of polyamide, polyacrylonitrile, acrylate polymer, polyacrylic acid, polyacrylate salt, polyvinylpyrrolidone, polyvinylether, polyvinylidene fluoride, or poly(vinylidene fluoride-hexafluoropropylene).

The secondary battery of this application further includes a packaging bag for accommodating the positive electrode, the negative electrode, the separator, and the electrolyte, as well as other components known in the field of secondary batteries, and this application imposes no limitation on the above other components. The packaging bag is not particularly limited in this application, which may be any packaging bag known in the art, provided that the objectives of this application can be achieved.

The preparation process of the secondary battery of this application is well known to those skilled in the art and is not particularly limited in this application. For example, it may include but is not limited to the following steps: stacking the positive electrode plate, the separator, and the negative electrode plate in sequence, and performing an operation such as winding or folding as needed to obtain an electrode assembly with a wound structure, placing the electrode assembly into the packaging bag, injecting the electrolyte into the packaging bag, and sealing to obtain the secondary battery; or stacking the positive electrode plate, the separator, and the negative electrode plate in sequence, then fixing four corners of an entire laminated structure with an adhesive tape to obtain an electrode assembly with a laminated structure, placing the electrode assembly into the packaging bag, injecting the electrolyte into the packaging bag, and sealing to obtain the secondary battery. In addition, an overcurrent prevention element, a guide plate, and the like may also be placed in the packaging bag as needed to prevent pressure rise, overcharge, and overdischarge inside the secondary battery.

According to a second aspect, this application provides an electronic apparatus including the above electrochemical apparatus.

The electronic apparatus of this application is not particularly limited, which may be any electronic apparatus known in the prior art. For example, the electronic apparatus may include but is not limited to a notebook computer, a pen-input computer, a mobile computer, an e-book player, a portable telephone, a portable fax machine, a portable copier, a portable printer, a stereo headset, a video recorder, a liquid crystal television, a portable cleaner, a portable CD player, a mini disc, a transceiver, an electronic notebook, a calculator, a memory card, a portable recorder, a radio, a backup power supply, a motor, an automobile, a motorcycle, a power-assisted bicycle, a bicycle, a lighting fixture, a toy, a game console, a clock, a power tool, a flash lamp, a camera, a large household battery, and a lithium-ion capacitor.

The following further illustrates the solutions of this application with reference to specific examples. Unless otherwise specified, the raw materials used in the following examples are all commercially available ordinary products, and the apparatuses or devices used are all purchased from conventional commercial channels. Various tests and evaluations are carried out according to the following methods. In addition, unless otherwise specified, “parts” and “%” are based on mass.

### Test for Battery Impedance:

At 25° C., the lithium-ion battery of each of the examples and comparative examples was charged and discharged under the following conditions: the lithium-ion battery was charged at a constant current of 1C to a cut-off voltage of 4.52 V, and then charged at constant voltage until the current was less than or equal to 0.05C. Then, the lithium-ion battery was discharged at a constant current of 0.5C to a cut-off voltage of 3 V. After three charge-discharge cycles were performed according to the above charge-discharge process, based on a discharge capacity of the last cycle, the battery was set to SOC 50%. Then, direct current internal resistance was measured by voltage drop displayed when a discharge pulse of 2.5C was applied for 10 seconds (a PNE-0506 charge-discharge apparatus was used). The resistance at this point was defined as initial resistance.

After 100 cycles were performed according to the above charge-discharge process, the lithium-ion battery was moved to 25° C., and SOC was set to 50%. Then, resistance after 100 cycles was measured by voltage drop displayed when a discharge pulse of 2.5C was applied for 10 seconds using the PNE-0506 charge-discharge apparatus. Battery impedance growth rate (%)=[(resistance after 100 cycles-initial resistance)/initial resistance]×100.

### Test for Battery Thickness Growth Rate:

The test temperature was 25° C. The lithium-ion battery of each of the examples and comparative examples was left standing for 30 minutes. After left standing, the lithium-ion battery was charged at a constant current of 0.2C to a voltage of 4.52 V and then discharged at a constant current of 0.2C to a voltage of 3.0 V. Subsequently, the thickness of the discharged lithium-ion battery was measured as a battery thickness before cycling.

Thereafter, the lithium-ion battery was charged and discharged at a constant current of 1C, with a charge cut-off voltage of 4.5 V and a discharge cut-off voltage of 3.0 V. One charge-discharge process was used as one cycle. A total of 300 cycles of charge-discharge operations were performed. Finally, the lithium-ion battery after 300 cycles was charged at a constant current of 0.2C to a cut-off voltage of 4.52 V and then discharged at a constant current of 0.2C to a voltage of 3.0 V. Then, the thickness of the discharged lithium-ion battery was measured as the battery thickness after cycling.

$$Battery thickness growth rate ( \% ) = [ ( battery thickness after cycling - battery thickness before cycling ) / battery thickness before cycling ] \times 100.$$

### Example 1-1

### <Preparation of Electrolyte>

In a dry argon atmosphere glove box, lithium hexafluorophosphate (LiPF₆) as a supporting electrolyte was dissolved in a solution including dimethyl carbonate, ethyl acetate, diethyl carbonate, ethylene carbonate (EC), propylene carbonate (PC), ethyl propionate (EP), and propyl propionate (PP). Based on a mass of the electrolyte, a mass percentage of lithium hexafluorophosphate was 12%; mass percentages of ethylene carbonate, dimethyl carbonate, ethyl propionate, and propyl propionate were as shown in Table 1 below; the balance was dimethyl carbonate, ethyl acetate, and diethyl carbonate; and a mass ratio of dimethyl carbonate, ethyl acetate, and diethyl carbonate was 2:1:2.

### <Preparation of Negative Electrode Plate>

Artificial graphite as a negative electrode active material, Super P as a negative electrode conductive agent, sodium carboxymethyl cellulose (CMC) as a thickener, and styrene-butadiene rubber (SBR) as a negative electrode binder were mixed at a mass ratio of 96.4:1.5:0.5:1.6, and then deionized water was added as a solvent to prepare a negative electrode slurry with a solid content of 30 wt %. The negative electrode slurry was uniformly applied on one surface of a copper foil as a negative electrode current collector with a thickness of 10 μm, and dried at 110° C. to obtain a negative electrode plate with one surface coated with a negative electrode active material layer. Then, the above steps were repeated on another surface of the negative electrode plate to obtain a negative electrode plate with both surfaces coated with negative electrode active material layers. After coated, the negative electrode plate was cold-pressed and cut into a negative electrode plate with a specification of 76.6 mm×875 mm for later use.

### <Preparation of Positive Electrode Plate>

LiₐCO_{1-b}M_{b}O_{2-b} (0.99≤a≤1.01, 0<b≤0.05, M being V (vanadium)) as a positive electrode active material, polyvinylidene fluoride (PVDF) as a positive electrode binder, and Super P as a positive electrode conductive agent were mixed at a mass ratio of 97:1.6:1.4, and then N-methylpyrrolidone (NMP) was added as a solvent to prepare a slurry with a solid content of 75 wt %, and the slurry was stirred well. The positive electrode slurry was uniformly applied on one surface of an aluminum foil as a positive electrode current collector with a thickness of 10 μm, and dried at 110° C. to obtain a positive electrode plate with one surface coated with a positive electrode active material. Then, the above steps were repeated on another surface of the positive electrode plate to obtain a positive electrode plate with both surfaces coated with positive electrode active materials. After coated, the positive electrode plate was cold-pressed and cut into a positive electrode plate with a specification of 74 mm×867 mm for later use.

### <Separator>

A polyethylene-polypropylene film with a thickness of 7 μm was used.

### <Preparation of Lithium-Ion Battery>

The positive electrode plate, separator, and negative electrode plate prepared above were stacked in sequence, so that the separator is located between the positive electrode plate and negative electrode plate for separation. Then, the resulting stack was wound to obtain an electrode assembly. After tab welding, the electrode assembly was placed into an aluminum-plastic film packaging shell and dried in a vacuum oven at 85° C. for 12 hours to remove moisture. Then, the electrolyte prepared above was injected. Processes such as vacuum sealing, standing, and formation were performed to obtain a lithium-ion battery.

### Examples 1-2 to 1-20 and Comparative Examples 1-1 to 1-6

These examples and comparative examples differed from Example 1-1 only in that the parameters were adjusted according to Table 1. When the parameters shown in Table 1 were higher than those in Example 1-1, the percentages of dimethyl carbonate, ethyl acetate, and diethyl carbonate were correspondingly reduced. When the parameters shown in Table 1 were lower than those in Example 1-2, the percentages of dimethyl carbonate, ethyl acetate, and diethyl carbonate were correspondingly increased, while the ratio of the mass percentages of dimethyl carbonate, ethyl acetate, and diethyl carbonate remained unchanged. “\” indicates that the electrolyte does not contain the substance. The performance test results of the examples and comparative examples are shown in Table 1.

TABLE 1

| | | | Mass | | | | | | |
|---|---|---|---|---|---|---|---|---|---|
| | | | percentage | Mass | Mass | | | | Thickness |
| | | Mass | B of | percentage | percentage | | | | growth rate |
| | Volumetric | percentage A | propylene | C of ethyl | D of propyl | | | Impedance | during |
| | energy density | of ethylene | carbonate | propionate | propionate | | (A + B)/ | growth | cycling |
| No. | (Wh/L) | carbonate (%) | (%) | (%) | (%) | D/C | (C + D) | rate (%) | (%) |
| Example 1-1 | 850 | 0.4 | 0.4 | 8 | 32 | 4 | 0.02 | 9.6% | 7.2% |
| Example 1-2 | 850 | 2 | 2 | 8 | 32 | 4 | 0.1 | 9.4% | 7.0% |
| Example 1-3 | 850 | 4 | 4 | 8 | 32 | 4 | 0.2 | 9.1% | 6.9% |
| Example 1-4 | 850 | 6 | 6 | 8 | 32 | 4 | 0.3 | 8.9% | 6.7% |
| Example 1-5 | 850 | 10 | 10 | 8 | 32 | 4 | 0.5 | 9.1% | 7.0% |
| Example 1-6 | 850 | 4 | 4 | 20 | 20 | 1 | 0.2 | 9.3% | 7.4% |
| Example 1-7 | 850 | 4 | 4 | 15 | 25 | 1.7 | 0.2 | 9.2% | 7.3% |
| Example 1-8 | 850 | 4 | 4 | 14 | 26 | 1.9 | 0.2 | 9.2% | 7.2% |
| Example 1-9 | 850 | 4 | 4 | 12 | 28 | 2.3 | 0.2 | 9.1% | 7.1% |
| Example 1-10 | 850 | 4 | 4 | 10 | 30 | 3.0 | 0.2 | 9.0% | 7.0% |
| Example 1-11 | 850 | 4 | 4 | 7.5 | 32.5 | 4.3 | 0.2 | 8.9% | 6.9% |
| Example 1-12 | 850 | 4 | 4 | 5 | 35 | 7 | 0.2 | 8.8% | 6.8% |
| Example 1-13 | 850 | 4 | 4 | 3.6 | 36.4 | 10 | 0.2 | 8.9% | 6.9% |
| Example 1-14 | 850 | 4 | 4 | 12 | 45 | 3.75 | 0.14 | 9.1% | 7.1% |
| Example 1-15 | 850 | 4 | 4 | 12 | 51 | 4.25 | 0.13 | 9.0% | 7.0% |
| Example 1-16 | 850 | 4 | 4 | 12 | 57 | 4.75 | 0.12 | 8.8% | 6.8% |
| Example 1-17 | 850 | 4 | 4 | 7.5 | 70 | 9.3 | 0.10 | 8.9% | 6.9% |
| Example 1-18 | 860 | 4 | 4 | 12 | 28 | 2.3 | 0.2 | 9.0% | 7.1% |
| Example 1-19 | 880 | 4 | 4 | 12 | 28 | 2.3 | 0.2 | 9.0% | 7.0% |
| Example 1-20 | 900 | 4 | 4 | 12 | 28 | 2.3 | 0.2 | 9.2% | 7.2% |
| Comparative | 840 | 0.4 | 0.4 | 8 | 32 | 4 | 0.02 | 9.3% | 7.2% |
| Example 1-1 | | | | | | | | | |
| Comparative | 910 | 0.4 | 0.4 | 8 | 32 | 4 | 0.02 | 9.4% | 7.3% |
| Example 1-2 | | | | | | | | | |
| Comparative | 850 | 4 | 4 | 22 | 18 | 0.8 | 0.2 | 9.4% | 7.5% |
| Example 1-3 | | | | | | | | | |
| Comparative | 850 | 4 | 4 | 3.5 | 36.5 | 10.4 | 0.2 | 9.0% | 7.7% |
| Example 1-4 | | | | | | | | | |
| Comparative | 850 | 0.4 | 0.4 | 10 | 32 | 3.2 | 0.019 | 9.7% | 7.3% |
| Example 1-5 | | | | | | | | | |
| Comparative | 850 | 10 | 10 | 6 | 32 | 5.3 | 0.53 | 9.2% | 7.2% |
| Example 1-6 | | | | | | | | | |

It can be seen from Table 1 that ethylene carbonate and propylene carbonate are added to the electrolyte of this application, and propyl propionate and ethyl propionate are used in combination with ethylene carbonate and propylene carbonate. By adjusting the mass percentages of the components to satisfy 0.02≤(A+B)/(C+D)≤0.5 and 1≤D/C≤10, both impedance growth rate and thickness growth rate after cycling of the lithium-ion battery with a high volumetric energy density can be reduced. In particular, when the electrolyte satisfies 2≤A≤10, 2≤B≤10, 10≤C≤15, and/or 45≤D≤70, the impedance growth rate and thickness growth rate after cycling of the lithium-ion battery can be further reduced. In particular, when the percentages of the components are adjusted so that the electrolyte satisfies 0.05≤(A+B)/(C+D)≤0.36 and/or 3≤D/C≤7, the impedance growth rate and thickness growth rate after cycling of the lithium-ion battery can be more significantly reduced.

### Examples 2-1 to 2-24

These examples were the same as Example 1-18 except that the parameters were adjusted according to Table 2. When the parameters shown in Table 2 were higher than those in Example 1-18, the percentages of dimethyl carbonate, ethyl acetate, and diethyl carbonate were correspondingly reduced. When the parameters shown in Table 2 were lower than those in Example 1-18, the percentages of dimethyl carbonate, ethyl acetate, and diethyl carbonate were correspondingly increased, while the ratio of the mass percentages of dimethyl carbonate, ethyl acetate, and diethyl carbonate remained unchanged. “\” indicates that the electrolyte does not contain the substance. The performance test results of the examples are shown in Table 2.

TABLE 2

| | | | | Mass percentage S | | | | Thickness |
|---|---|---|---|---|---|---|---|---|
| | Mass | Mass | Mass percentage | of Lithium | | | | growth rate |
| | percentage | percentage Q | R of 1,3,6- | bis(trifluorometh- | Type of | Percentage U | Impedance | during |
| | P of | of 1,3-propane | hexanetricarbonitrile | anesulfonyl)imide | first | of first | growth | cycling |
| No. | FEC (%) | sultone (%) | (%) | (%) | substance | substance (%) | rate (%) | (%) |
| Example 2-1 | 10 | \ | \ | \ | \ | \ | 8.8 | 7 |
| Example 2-2 | 12 | \ | \ | \ | \ | \ | 8.6 | 6.9 |
| Example 2-3 | 20 | \ | \ | \ | \ | \ | 8.7 | 6.8 |
| Example 2-4 | 40 | \ | \ | \ | \ | \ | 9.5 | 6.7 |
| Example 2-5 | \ | 1 | \ | \ | \ | \ | 8.8 | 7.1 |
| Example 2-6 | \ | 2 | \ | \ | \ | \ | 8.6 | 7 |
| Example 2-7 | \ | 4 | \ | \ | \ | \ | 8.5 | 7 |
| Example 2-8 | \ | 6 | \ | \ | \ | \ | 8.7 | 7.2 |
| Example 2-9 | 18 | \ | 2 | \ | \ | \ | 8.6 | 7 |
| Example 2-10 | 18 | \ | 2.4 | \ | \ | \ | 8.6 | 6.8 |
| Example 2-11 | 18 | \ | 2.8 | \ | \ | \ | 8.5 | 6.7 |
| Example 2-12 | 18 | \ | 3 | \ | \ | \ | 8.7 | 6.9 |
| Example 2-13 | 18 | \ | 2.4 | 0.5 | \ | \ | 8.6 | 6.8 |
| Example 2-14 | 18 | \ | 2.4 | 0.7 | \ | \ | 8.5 | 6.7 |
| Example 2-15 | 18 | \ | 2.4 | 0.9 | \ | \ | 8.4 | 6.6 |
| Example 2-16 | 18 | \ | 2.4 | 1 | \ | \ | 8.7 | 6.8 |
| Example 2-17 | 18 | \ | 2.4 | 0.7 | Vinyl | 2 | 8.3 | 6.7 |
| | | | | | sulfate | | | |
| Example 2-18 | 18 | \ | 2.4 | 0.7 | Vinyl | 2.3 | 8.2 | 6.7 |
| | | | | | sulfate | | | |
| Example 2-19 | 18 | \ | 2.4 | 0.7 | Vinyl | 2.7 | 8 | 6.6 |
| | | | | | sulfate | | | |
| Example 2-20 | 18 | \ | 2.4 | 0.7 | Vinyl | 3 | 8.1 | 6.6 |
| | | | | | sulfate | | | |
| Example 2-21 | 18 | \ | 2.4 | 0.7 | Vinyl | 2 | 8.2 | 6.7 |
| | | | | | bisulfate | | | |
| Example 2-22 | 18 | \ | 2.4 | 0.7 | Vinyl | 2.3 | 8 | 6.6 |
| | | | | | bisulfate | | | |
| Example 2-23 | 18 | \ | 2.4 | 0.7 | Vinyl | 2.7 | 7.8 | 6.5 |
| | | | | | bisulfate | | | |
| Example 2-24 | 18 | \ | 2.4 | 0.7 | Vinyl | 3 | 8 | 6.6 |
| | | | | | bisulfate | | | |

It can be seen from Table 2 that adjusting the mass percentage P % of fluoroethylene carbonate in the electrolyte to satisfy 10<P≤40 can reduce the thickness growth rate during cycling of the lithium-ion battery. In particular, when 12≤P≤20, the thickness growth rate during cycling of the lithium-ion battery can be further reduced. In particular, adjusting the mass percentage Q % of 1,3-propane sultone in the electrolyte to satisfy 1≤Q≤6 can further reduce the impedance growth rate and cycling thickness growth rate during cycling of the lithium-ion battery. In particular, when 2≤Q≤4 is satisfied, the impedance growth rate and thickness growth rate during cycling of the lithium-ion battery can be further reduced.

In particular, the electrolyte is adjusted to include 1,3,6-hexanetricarbonitrile. When the mass percentage R % of 1,3,6-hexanetricarbonitrile satisfies 2≤R≤3, the thickness growth rate during cycling of the lithium-ion battery can be further reduced. In particular, when 2.4≤R≤2.8 is satisfied, both the impedance growth rate and thickness growth rate during cycling can be reduced. Further, lithium bis(trifluoromethanesulfonyl)imide is used in combination with the above components. When the mass percentage S % satisfies 0.5≤S≤1, the thickness growth rate during cycling of the lithium-ion battery can be further reduced. In particular, when 0.7≤S≤0.9 is satisfied, both the impedance growth rate and thickness growth rate during cycling of the lithium-ion battery can be reduced.

In particular, the first substance is further added to the electrolyte. When the mass percentage U % of the first substance satisfies 2≤U≤3, the first substance can cooperate with the foregoing components to further reduce the impedance growth rate and thickness growth rate during cycling of the lithium-ion battery. In particular, when the mass percentage of the first substance satisfies 2.3≤U≤2.7, the impedance growth rate and thickness growth rate during cycling of the lithium-ion battery can be further reduced.

### Examples 3-1 to 3-10

These examples were the same as Example 2-22 except that the parameters were adjusted according to Table 3. When the parameters shown in Table 3 were higher than those in Example 2-22, the percentages of dimethyl carbonate, ethyl acetate, and diethyl carbonate were correspondingly reduced. When the parameters shown in Table 3 were lower than those in Example 2-22, the percentages of dimethyl carbonate, ethyl acetate, and diethyl carbonate were correspondingly increased, while the ratio of the mass percentages of dimethyl carbonate, ethyl acetate, and diethyl carbonate remained unchanged. “\” indicates that the electrolyte does not contain the substance. The performance test results of the examples are shown in Table 3.

TABLE 3

| | Mass percentage X of | | Mass percentage of 6- | | Thickness |
|---|---|---|---|---|---|
| | dicyclohexyl(tri- | Mass percentage Y of 2,3- | (morpholin-4-yl)pyridine-3- | Impedance | growth rate |
| | fluoromethane- | pyridinedicarboxylic | boronic acid pinacol ester | growth rate | during cycling |
| No. | sulfonyloxy)borane (%) | anhydride (%) | (%) | (%) | (%) |
| Example 3-1 | 0.5 | \ | \ | 7.9 | 6.5 |
| Example 3-2 | 0.7 | \ | \ | 7.7 | 6.4 |
| Example 3-3 | 1 | \ | \ | 7.9 | 6.6 |
| Example 3-4 | \ | 0.3 | \ | 8 | 6.5 |
| Example 3-5 | \ | 0.5 | \ | 7.8 | 6.4 |
| Example 3-6 | \ | 0.8 | \ | 7.9 | 6.5 |
| Example 3-7 | \ | \ | 0.5 | 7.9 | 6.4 |
| Example 3-8 | \ | \ | 0.7 | 7.8 | 6.3 |
| Example 3-9 | \ | \ | 0.8 | 7.9 | 6.5 |
| Example 3-10 | 0.7 | 0.5 | 0.7 | 7.5 | 6.1 |

It can be seen from Table 3 that the electrolyte is controlled to further include at least one of dicyclohexyl(trifluoromethanesulfonyloxy)borane, 2,3-pyridinedicarboxylic anhydride, or 6-(morpholin-4-yl)pyridine-3-boronic acid pinacol ester. When the mass percentages of the components respectively satisfy 0.5≤X≤1, 0.3≤Y≤0.8, and 0.5≤Z≤0.8, the impedance growth rate and thickness growth rate during cycling of the lithium-ion battery can be further reduced. In particular, when the electrolyte simultaneously includes dicyclohexyl(trifluoromethanesulfonyloxy)borane, 2,3-pyridinedicarboxylic anhydride, and 6-(morpholin-4-yl)pyridine-3-boronic acid pinacol ester, the impedance growth rate and thickness growth rate during cycling of the lithium-ion battery can be more significantly reduced.

5 The above are merely preferred embodiments of this application and are not intended to limit this application. Any modifications, equivalent replacements, and improvements made within the principles of this application shall be included in the protection scope of this application.

What is claimed is:

1. An electrochemical apparatus, comprising a positive electrode, a negative electrode, and an electrolyte; wherein a volumetric energy density of the electrochemical apparatus is 850 Wh/L to 900 Wh/L; and
the electrolyte comprises ethylene carbonate, propylene carbonate, ethyl propionate and propyl propionate; based on a mass of the electrolyte, a mass percentage of ethylene carbonate is A %, a mass percentage of propylene carbonate is B %, a mass percentage of ethyl propionate is C %, and a mass percentage of propyl propionate is D %, wherein
$$0.02 \leq ( A + B ) / ( C + D ) \leq 0.5 , and 1 \leq D / C \leq 10.$$

2. The electrochemical apparatus according to claim 1, wherein the electrolyte satisfies at least one of the following conditions:
$$2 \leq A \leq 10 ; \qquad ( 1 )$$
$$2 \leq B \leq 10 ; \qquad ( 2 )$$
$$10 \leq C \leq 15 ; \qquad ( 3 )$$
$$45 \leq D \leq 70 ; \qquad ( 4 )$$
$$0.05 \leq ( A + B ) / ( C + D ) \leq 0.36 ; or \qquad ( 5 )$$
$$3 \leq D / C \leq 7. \qquad ( 6 )$$

3. The electrochemical apparatus according to claim 1, wherein the electrolyte further comprises fluoroethylene carbonate and 1,3-propane sultone; and
based on the mass of the electrolyte, a mass percentage of the fluoroethylene carbonate is P %, and a mass percentage of the 1,3-propane sultone is Q %; wherein 10≤P≤40, and 1≤Q≤6.

4. The electrochemical apparatus according to claim 2, wherein the electrolyte further comprises fluoroethylene carbonate and 1,3-propane sultone; and
based on the mass of the electrolyte, a mass percentage of the fluoroethylene carbonate is P %, and a mass percentage of the 1,3-propane sultone is Q %; wherein 10≤P≤40, and 1≤Q≤6.

5. The electrochemical apparatus according to claim 3, wherein 12≤P≤20; or 2≤Q≤4.

6. The electrochemical apparatus according to claim 3, wherein the electrolyte further comprises 1,3,6-hexanetricarbonitrile; and
based on the mass of the electrolyte, a mass percentage of the 1,3,6-hexanetricarbonitrile is R %, wherein 2≤R≤3.

7. The electrochemical apparatus according to claim 4, wherein the electrolyte further comprises 1,3,6-hexanetricarbonitrile; and
based on the mass of the electrolyte, a mass percentage of the 1,3,6-hexanetricarbonitrile is R %, wherein 2≤R≤3.

8. The electrochemical apparatus according to claim 6, wherein the electrolyte further comprises lithium bis(trifluoromethanesulfonyl)imide; and
based on the mass of the electrolyte, a mass percentage of the lithium bis(trifluoromethanesulfonyl)imide is S %, wherein 0.5≤S≤1.

9. The electrochemical apparatus according to claim 7, wherein the electrolyte further comprises lithium bis(trifluoromethanesulfonyl)imide; and
based on the mass of the electrolyte, a mass percentage of the lithium bis(trifluoromethanesulfonyl)imide is S %, wherein 0.5≤S≤1.

10. The electrochemical apparatus according to claim 5, wherein the electrolyte further comprises a first substance, and the first substance is selected from vinyl sulfate or vinyl bisulfate; and
based on the mass of the electrolyte, a mass percentage of the first substance is U %, wherein 2≤U≤3.

11. The electrochemical apparatus according to claim 6, wherein the electrolyte further comprises a first substance, and the first substance is selected from vinyl sulfate or vinyl bisulfate; and
based on the mass of the electrolyte, a mass percentage of the first substance is U %, wherein 2≤U≤3.

12. The electrochemical apparatus according to claim 8, wherein the electrolyte further comprises a first substance, and the first substance is selected from vinyl sulfate or vinyl bisulfate; and
based on the mass of the electrolyte, a mass percentage of the first substance is U %, wherein 2≤U≤3.

13. The electrochemical apparatus according to claim 5, wherein the electrolyte satisfies at least one of the following conditions:
(1) the electrolyte further comprises dicyclohexyl(trifluoromethanesulfonyloxy)borane; and based on the mass of the electrolyte, a mass percentage of the dicyclohexyl(trifluoromethanesulfonyloxy)borane is X %, wherein 0.5≤X≤1;
(2) the electrolyte further comprises 2,3-pyridinedicarboxylic anhydride; and based on the mass of the electrolyte, a mass percentage of the 2,3-pyridinedicarboxylic anhydride is Y %, wherein 0.3≤Y≤0.8; or
(3) the electrolyte further comprises 6-(morpholin-4-yl)pyridine-3-boronic acid pinacol ester; and based on the mass of the electrolyte, a mass percentage of the 6-(morpholin-4-yl)pyridine-3-boronic acid pinacol ester is Z %, wherein 0.5≤Z≤0.8.

14. The electrochemical apparatus according to claim 6, wherein the electrolyte satisfies at least one of the following conditions:
(1) the electrolyte further comprises dicyclohexyl(trifluoromethanesulfonyloxy)borane; and based on the mass of the electrolyte, a mass percentage of the dicyclohexyl(trifluoromethanesulfonyloxy)borane is X %, wherein 0.5≤X≤1;
(2) the electrolyte further comprises 2,3-pyridinedicarboxylic anhydride; and based on the mass of the electrolyte, a mass percentage of the 2,3-pyridinedicarboxylic anhydride is Y %, wherein 0.3≤Y≤0.8; or
(3) the electrolyte further comprises 6-(morpholin-4-yl)pyridine-3-boronic acid pinacol ester; and based on the mass of the electrolyte, a mass percentage of the 6-(morpholin-4-yl)pyridine-3-boronic acid pinacol ester is Z %, wherein 0.5≤Z≤0.8.

15. The electrochemical apparatus according to claim 8, wherein the electrolyte satisfies at least one of the following conditions:
(1) the electrolyte further comprises dicyclohexyl(trifluoromethanesulfonyloxy)borane; and based on the mass of the electrolyte, a mass percentage of the dicyclohexyl(trifluoromethanesulfonyloxy)borane is X %, wherein 0.5≤X≤1;
(2) the electrolyte further comprises 2,3-pyridinedicarboxylic anhydride; and based on the mass of the electrolyte, a mass percentage of the 2,3-pyridinedicarboxylic anhydride is Y %, wherein 0.3≤Y≤0.8; or
(3) the electrolyte further comprises 6-(morpholin-4-yl)pyridine-3-boronic acid pinacol ester; and based on the mass of the electrolyte, a mass percentage of the 6-(morpholin-4-yl)pyridine-3-boronic acid pinacol ester is Z %, wherein 0.5≤Z≤0.8.

16. The electrochemical apparatus according to claim 1, wherein the positive electrode comprises a positive electrode current collector and a positive electrode active material layer located on at least a part of a surface of the positive electrode current collector, the positive electrode active material layer comprises a positive electrode active material, and the positive electrode active material has a general formula of LiₐCo₁₋₆M_{b}O_{2-b}, wherein 0.99≤a≤1.01, 0.01≤b≤0.05; and Mis at least one selected from the group consisting of Na, Mg, Al, Zr, Ti, Y, Ni, Mn, V, Cr, La, and Ce.

17. An electronic apparatus, comprising an electrochemical apparatus; the electrochemical apparatus comprises a positive electrode, a negative electrode, and an electrolyte; wherein a volumetric energy density of the electrochemical apparatus is 850 Wh/L to 900 Wh/L; and
the electrolyte comprises ethylene carbonate, propylene carbonate, ethyl propionate and propyl propionate; based on a mass of the electrolyte, a mass percentage of ethylene carbonate is A %, a mass percentage of propylene carbonate is B %, a mass percentage of ethyl propionate is C %, and a mass percentage of propyl propionate is D %, wherein
$$0.02 ⩽ ( A + B ) / ( C + D ) ⩽ 0.5 , and 1 ⩽ D / C ⩽ 10.$$

18. The electronic apparatus according to claim 17, wherein the electrolyte satisfies at least one of the following conditions:
$$2 \leq A \leq 10 ; \qquad ( 1 )$$
$$2 \leq B \leq 10 ; \qquad ( 2 )$$
$$10 \leq C \leq 15 ; \qquad ( 3 )$$
$$45 \leq D \leq 70 ; \qquad ( 4 )$$
$$0.05 \leq ( A + B ) / ( C + D ) \leq 0.36 ; or \qquad ( 5 )$$
$$3 \leq D / C \leq 7. \qquad ( 6 )$$

19. The electronic apparatus according to claim 17, wherein the electrolyte further comprises fluoroethylene carbonate and 1,3-propane sultone; and
based on the mass of the electrolyte, a mass percentage of the fluoroethylene carbonate is P %, and a mass percentage of the 1,3-propane sultone is Q %; wherein 10≤P≤40, and 1≤Q≤6.

20. The electronic apparatus according to claim 19, wherein 12≤P≤20; or 2≤Q≤4.
